(19) United States
(12) Patent Application Publication
(10) Pub. No.: US 2018/0102666 A1
(43) Pub. Date: Apr. 12, 2018

(54) BATTERY INDUCTIVE CHARGING DEVICE

(71) Applicant: Robert Bosch GmbH, Stuttgart (DE)

(72) Inventors: Georgios Margaritis, Schwieberdingen (DE); Juergen Mack, Goeppingen (DE)

(21) Appl. No.: 15/566,835

(22) PCT Filed: Apr. 7, 2016
(86) PCT No.: PCT/EP2016/057634

§ 371 Date: Oct. 16, 2017

(30) Foreign Application Priority Data
May 5, 2015 (DE) 10 2015 208 254.7

(51) Int. Cl. H02J 7/02; B60R 16/03; H02J 7/00

(52) U.S. Cl. CPC H02J 7/025; H02J 7/0044; B60R 16/03

(57) ABSTRACT

An inductive rechargeable battery charging apparatus for a vehicle, having at least one DC voltage transformer and having at least one inductive charging unit that is provided in order to supply energy by way of the DC voltage transformer, is described.

### FIELD

The present invention relates to an inductive rechargeable battery charging apparatus for a vehicle.

### BACKGROUND INFORMATION

An inductive rechargeable battery charging apparatus for a vehicle, having at least one DC voltage transformer and having at least one inductive charging unit that is provided in order to supply energy by way of the DC voltage transformer, is provided.

Rechargeable battery packs, in particular handheld power tool rechargeable battery packs, can thereby be charged while the vehicle is being driven. Driving time can advantageously be utilized. High availability for a handheld power tool can be achieved. Particularly good user convenience can be achieved. Conversion of a supply voltage into an AC voltage can be avoided. A particularly efficient inductive rechargeable battery charging apparatus can be furnished. A “vehicle” is to be understood in this context in particular as a motor vehicle, preferably a motor-driven road vehicle. An “inductive charging unit” is to be understood in this context in particular as a unit for charging at least one rechargeable battery pack, which unit is provided, in at least one charging state, in order to convey a charging current to the rechargeable battery pack at least in part by electromagnetic induction. Preferably the induction unit encompasses at least one induction coil, embodied as a primary coil, which is provided, in at least one operating state, in order to generate a magnetic field by way of an applied electrical energy, in particular by way of an AC voltage, which field generates an alternating electric current in an induction coil of the rechargeable battery pack. The induction coil is provided in particular in order to transform an alternating electromagnetic field into an alternating electric current and/or vice versa. Preferably the alternating field has a frequency from 10 to 500 kHz, particularly preferably from 100 to 120 kHz. Preferably the inductive charging unit encompasses at least one core element in order to increase an inductance of the at least one induction coil. A “rechargeable battery pack” is to be understood in this context in particular as an energy storage unit, in particular as an energy storage unit embodied as an inductively charged rechargeable battery pack, that has at least one induction coil embodied as a secondary coil. Preferably the rechargeable battery pack is embodied as a handheld power tool rechargeable battery pack and/or as a home appliance rechargeable battery pack, and is provided in order to supply a machine, in particular a handheld power tool and/or a home appliance, with electrical energy. Preferably the rechargeable battery pack is provided in order to supply at least one electrical drive unit of the machine with electrical energy. Preferably the rechargeable battery pack is provided for temporary storage of electrical energy. A “handheld power tool” is to be understood in this context in particular as a power drill, a hammer drill, a saw, a plane, a screwdriver, a milling cutter, a grinder, an angle grinder, an outdoor power tool, in particular a lawnmower, a vacuum, and/or a multifunction tool. A “home appliance” is to be understood in this context in particular as a device that is provided in order to be used in a home and is provided in particular in order to perform and/or assist with household tasks and/or for personal care, entertainment, sports activity, and/or information transmission. A “DC voltage transformer” is to be understood in this context in particular as a unit that is provided in order to transform an input current having a DC voltage into an output current having a DC voltage. Preferably the DC voltage transformer has an energy buffer and an electronic switching system. “Provided” is to be understood in particular to mean specially programmed, designed, and/or equipped. The fact that an object is provided for a specific function is to be understood in particular to mean that the object performs and/or executes that specific function in at least one utilization state and/or operating state.

In accordance with the present invention, the DC voltage transformer is provided in order to transform a voltage of an energy reservoir into a higher voltage in order to supply power to the at least one inductive charging unit. An existing inductive charging unit can thereby advantageously be used in a vehicle. Low development costs and/or production costs can be achieved. Advantageous utilization of the energy reservoir can be achieved. An “energy reservoir” is to be understood in this context in particular as a low-voltage energy reservoir, for example a lead-acid rechargeable battery. Preferably the energy reservoir is provided in order to supply energy to an electrical system of the vehicle. Preferably the energy reservoir has an output voltage of between 12 V inclusive and 24 V inclusive. Preferably the DC voltage transformer is provided for an input voltage of less than or equal to 30 V, preferably less than or equal to 24 V, and particularly preferably less than or equal to 12 V. Preferably the DC voltage transformer has at least one current output having an output voltage of at least 230 V, preferably of at least 250 V, and particularly preferably of at least 300 V, and very particularly preferably of at least 325 V. It is possible for the DC voltage transformer to have a plurality of current outputs. It is possible for the current outputs of the DC voltage transformer to have an at least substantially identical output voltage or different output voltages. Preferably the DC voltage transformer and the inductive charging unit have housings embodied separately from one another. Alternatively, the inductive rechargeable battery charging apparatus can encompass at least one unit having a housing in which the at least one DC voltage transformer and the at least one inductive charging unit are disposed. Preferably the inductive rechargeable battery charging apparatus encompasses at least one unit having a housing in which the at least one DC voltage transformer and a plurality of inductive charging units, in particular two inductive charging units, are disposed.

In an advantageous embodiment, the DC voltage transformer has a service temperature range having a lower limit of at maximum −10 degrees Celsius and an upper limit of at minimum 50 degrees Celsius. An inductive rechargeable battery charging apparatus usable in particularly versatile fashion can thereby be furnished. A particularly robust inductive rechargeable battery charging apparatus can be furnished. Preferably the DC voltage transformer has a service temperature range of at maximum −20 degrees to at minimum 70 degrees, preferably from at maximum −30 degrees to at minimum 80 degrees, and particularly preferably from at maximum −40 to at maximum 100 degrees.

Advantageously, the at least one inductive charging unit is provided in order to be supplied selectably with direct current or alternating current. An inductive rechargeable battery charging apparatus usable in particularly versatile fashion can thereby be furnished. Costs for development and/or production can be further reduced. User convenience can be further enhanced. Preferably the inductive charging unit is provided in order to be supplied with an electrical grid voltage that has an effective voltage of approximately 230 V and a frequency of approximately 50 Hz.

Advantageously, the at least one inductive charging unit encompasses a functional unit that is provided in order to automatically detect a frequency of an applied supply voltage. A particularly robust inductive rechargeable battery charging apparatus can thereby be furnished. Incorrect operation of the inductive rechargeable battery charging apparatus can be particularly reliably avoided. A “frequency” is to be understood in this context in particular as a number of polarity changes of the voltage per unit time, including the absence of polarity changes. In particular, the functional unit is provided in order to automatically detect whether the supply voltage is embodied as a DC voltage or as an AC voltage. It is possible for the functional unit to be provided in order to sense a voltage value of the supply voltage.

In an advantageous embodiment, the inductive rechargeable battery charging apparatus encompasses a plurality of inductive charging units that are provided in order to supply energy by way of the at least one DC voltage transformer. As a result, a plurality of rechargeable battery packs can be charged simultaneously or a plurality of rechargeable battery packs can be disposed simultaneously in a charging position irrespective of a charging sequence. An efficiency of the inductive rechargeable battery charging apparatus can thereby be further increased. A parts count and/or a number of electrical connecting leads can be minimized. A particularly economical inductive rechargeable battery charging apparatus can be furnished. Preferably the inductive rechargeable battery charging apparatus has a plurality of electrical connecting leads that, in an installed state, connect the DC voltage transformer to a respective inductive charging unit.

Advantageously, the inductive rechargeable battery charging apparatus encompasses a distributor unit that has a plurality of terminals that are provided at least for temporary connection to a respective inductive charging unit. A plurality of rechargeable battery packs can thereby be charged in particularly simple fashion. Replacement rechargeable battery packs can be charged. Rechargeable battery packs for handheld power tools and/or home appliances for different applications can be charged. In addition, a short electrical connecting cable between the energy reservoir and the DC voltage transformer can be implemented. The quantity of metallic conductive material, in particular copper, can be reduced. Power dissipation can be limited. The distributor unit is disposed, with reference to an energy flow, between the DC voltage transformer and the plurality of inductive charging units.

In an advantageous embodiment, an inductive rechargeable battery charging apparatus has at least one plug connection that is provided in order to connect the at least one inductive charging unit selectably to the distributor unit or to an electrical grid connection. The inductive rechargeable battery charging apparatus can thereby be operated in particularly simple fashion using an electrical grid connection. “Connect” is to be understood in this context in particular to mean electrically connect, in particular connect to an energy transfer system. A “plug connection” is to be understood in this context in particular as a connection that is detachable without tools. It is possible for the plug connection to have at least one adapter that is provided in order to connect the inductive unit to the distributor unit or to the electrical grid connection.

In an advantageous embodiment, an inductive rechargeable battery charging apparatus has at least one holding unit having a receptacle for the at least one inductive charging unit and a further receptacle for at least one rechargeable battery pack, which is provided in order to immobilize the rechargeable battery pack at least for a charging operation. A rechargeable battery pack can thereby be brought into a charging position in particularly simple and/or rapid fashion. An inductive rechargeable battery charging apparatus that is usable in particularly simple fashion can be implemented. An efficient charging operation can be achieved. Preferably, the receptacle for the at least one inductive charging unit is provided in order to immobilize the inductive charging unit at least for the charging operation. It is possible for the holding unit to have at least one clamping unit and/or latching unit that is provided in order to immobilize the inductive charging unit and/or the rechargeable battery pack at least for the charging operation. Preferably the receptacle for the inductive charging unit is provided for insertion and/or removal of the inductive charging unit without the use of tools. Preferably the further receptacle for the rechargeable battery pack is provided for insertion and/or removal of the rechargeable battery pack without the use of tools. The holding unit is preferably provided for installation in and/or on a support system, for example a shelf system and/or a rack system.

In accordance with the present invention the inductive rechargeable battery charging apparatus may have at least one holding unit that is provided in order to position the at least one inductive charging unit and at least one handheld power tool relative to one another for a charging operation. A handheld power tool can thereby be brought into a charging position in particularly simple and/or rapid fashion. Preferably, the holding unit is provided for insertion and/or removal of the handheld power tool without the use of tools. It is possible for the inductive rechargeable battery charging apparatus to have a holding unit that is provided in order to position the at least one inductive charging unit and at least one home appliance relative to one another for a charging operation.

In accordance with the present invention, the holding unit may have at least one conversion unit that is provided in order to convert a gravitational force into a positioning force acting at least substantially perpendicularly to the gravitational force. Particularly secure positioning of the inductive charging unit, of the rechargeable battery pack, of the handheld power tool, and/or of the home appliance can thereby be achieved. An efficiency of the charging operation can be further increased.

“At least substantially perpendicularly” is to be understood in this context in particular to mean that the directions of the gravitational force and of the positioning force enclose an angle in a range from 70 degrees to 110 degrees, preferably in a range from 80 degrees to 100 degrees, and by preference in a range from 85 degrees to 95 degrees. A “positioning force” is to be understood in this context in particular as a force that acts on the inductive charging unit, on the rechargeable battery pack, on the handheld power tool, and/or on the home appliance toward a charging position. A “direction of a gravitational force” is to be understood in this context in particular as a direction in which the gravitational force acts on elements disposed in the vehicle in the context of an orientation provided for the vehicle, relative to a gravitational field, in which a bottom of the vehicle is aligned substantially parallel to a surface of the earth.

Advantageously, the inductive rechargeable battery charging apparatus encompasses at least one charging bay that encompasses the at least one inductive charging unit and is provided for reception of at least one handheld tool case. An inductive rechargeable battery charging apparatus can thereby be furnished for a wide range of uses. Utilization of the inductive rechargeable battery charging apparatus can be further simplified. A “charging bay” is to be understood in this context in particular as a unit that is provided in order to support the handheld tool case for a charging operation, for storage, and/or for transport, preferably in a building or in a vehicle. Preferably the handheld tool case and the charging bay are embodied to be connectable to one another fixedly, preferably without the use of tools. Preferably, the handheld power tool case and the charging bay are embodied to be separable from one another nondestructively, preferably without the use of tools. Preferably the handheld tool case is held in the charging bay as a result of a gravitational force and/or by way of a latching connection and/or by way of a clamping apparatus. The charging bay is preferably provided for installation in a support system, for example in a shelf system and/or in a rack system. Preferably the charging bay has a plurality of inductive charging units, preferably two inductive charging units. A “handheld tool case” is to be understood in this context in particular as a case, carryable by hand, that is provided in order to protect a transported object stored in a case interior, in particular a rechargeable battery pack, a handheld power tool and/or a home appliance, or a plurality of transported objects, from dust, moisture, mechanical action, and/or further environmental influences. Preferably the handheld tool case is provided in order to support the transported object for wireless energy transfer. Preferably the handheld tool case is provided in order to be inserted into the charging bay. The charging bay is preferably provided in order to furnish energy for wireless energy transfer.

In accordance with the present invention, a method is also provided in which an inductive charging unit in a vehicle is supplied with energy by way of a DC voltage transformer. An inductive charging unit or a plurality of inductive charging units can thereby be supplied particularly efficiently with energy, in particular for a charging operation.

The inductive battery apparatus according to the present invention is not meant to be limited to the utilization and embodiment described above. In particular, the inductive battery apparatus according to the present invention can have, in order to achieve a functionality described herein, a number of individual elements, components, and units which differs from the number recited herein.

### BRIEF DESCRIPTION OF THE DRAWINGS

Further advantages of the present invention are evident from the description below of the figures. The figures depict three exemplifying embodiments of the invention. The figures and the description below contain numerous features in combination. One skilled in the art will appropriately consider the features, including individually, and combine them into useful further combinations.

FIG. 1 is a diagram of an inductive rechargeable battery charging apparatus according to the present invention.

FIG. 2 is a perspective view of an inductive charging unit of the inductive rechargeable battery charging apparatus.

FIG. 3 is a perspective view of a holding unit of the inductive rechargeable battery charging apparatus.

FIG. 4 shows the holding unit with a handheld power tool inserted.

FIG. 5 shows a support system with a holding unit installed.

FIG. 6 is a diagram of a further exemplifying embodiment of the inductive rechargeable battery charging apparatus.

FIG. 7 is a perspective view of a charging bay of the inductive rechargeable battery charging apparatus.

FIG. 8 shows the charging bay with a handheld tool case inserted.

FIG. 9 is a diagram of a third exemplifying embodiment of the inductive rechargeable battery charging apparatus.

### DETAILED DESCRIPTION OF EXAMPLE EMBODIMENTS

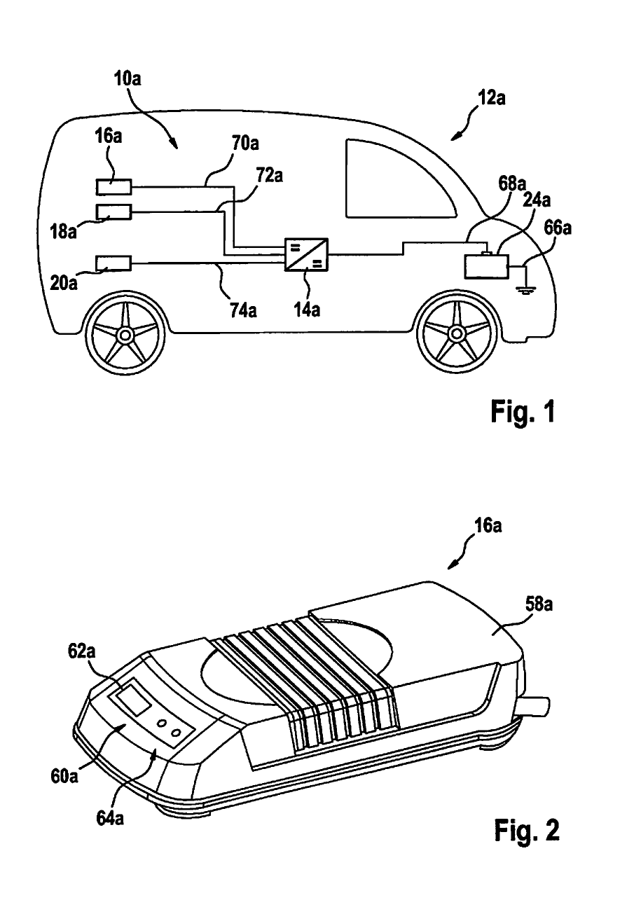

FIG. 1 shows an inductive rechargeable battery charging apparatus 10a for a vehicle 12a, having a DC voltage transformer 14a and an inductive charging unit 16a, 18a, 20a that is provided in order to supply energy by way of DC voltage transformer 14a.

Inductive rechargeable battery charging apparatus 10a is provided in order to charge rechargeable battery packs 46a, for example to charge rechargeable handheld tool battery packs for handheld power tools 48a such as screwdrivers, drills, saws, vacuums, or grinders, or for outdoor power tools such as lawnmowers or hedge clippers. Inductive rechargeable battery charging apparatus 10a is provided for installation and/or operation in a vehicle 12a, in particular in a motor vehicle. Rechargeable battery packs 46a are respectively provided in order to supply at least one drive unit of handheld power tool 48a, or of the outdoor power tool, with electrical energy. Rechargeable battery packs 46a are provided for temporary storage of energy, and are embodied to be rechargeable.

In the present exemplifying embodiment, inductive rechargeable battery charging apparatus 10a has a plurality of inductive charging units 16a, 18a, 20a. In the present exemplifying embodiment, inductive charging units 16a, 18a, 20a are embodied analogously to one another, and only a first of inductive charging units 16a will therefore be described in further detail below. Inductive charging unit 16a is provided in order to charge rechargeable battery pack 46a in a charging operation. Rechargeable battery pack 46a is provided in order to be coupled to inductive charging unit 16a. Inductive charging unit 16a is provided, in a state coupled to rechargeable battery pack 46a, in order to transfer energy to rechargeable battery pack 46a. Inductive charging unit 16a has a charging coil and a housing 58a. The charging coil is embodied as a primary coil. The charging coil is provided for inductive energy transfer to rechargeable battery pack 46a. The charging coil is provided in order to transmit, i.e. radiate, energy.

Inductive charging unit 16a has an indicating unit 60a that is provided in order to output information to an operator (see FIG. 2). Indicating unit 60a is provided for optical output of information. Alternatively, it is possible for indicating unit 60a to be provided for acoustic and/or haptic output of information. In a charging state, an operator can gather from indicating unit 60a information regarding a charging state of the induction rechargeable battery. Indicating unit 60a encompasses a display 62a and several LEDs 64a. Alternatively or additionally, however, other configurations of indicating unit 60a are also possible.

In the present exemplifying embodiment, inductive rechargeable battery charging apparatus 10a has exactly one DC voltage transformer 14a. Vehicle 12a has an energy reservoir 24a that is provided in order to supply an electrical system of vehicle 12a with electrical energy. Vehicle 12a has an electrical connection 66a between energy reservoir 24a and an electrical ground. DC voltage transformer 14a is provided in order to transform a voltage of energy reservoir 24a into a higher voltage in order to supply energy to the at least one inductive charging unit 16a. Energy reservoir 24a has a rated voltage of 12 V. In the present exemplifying embodiment, energy reservoir 24a is embodied as a lead-acid rechargeable battery. Energy reservoir 24a is embodied to be rechargeable. The motor vehicle encompasses a generator that is provided in order to furnish energy for charging energy reservoir 24a.

DC voltage transformer 14a is provided in order to transform the output voltage of energy reservoir 24a from 12V to an input voltage of inductive charging units 16a, 18a, 20a of 300 V. DC voltage transformer 14a is provided in order to supply the plurality of inductive charging units 16a, 18a, 20a with energy. Vehicle 12a, and inductive rechargeable battery charging apparatus 10a disposed in vehicle 12a, are exposed to temperature fluctuations, for example because of differing weather conditions. In the present exemplifying embodiment, DC voltage transformer 14a has a service temperature range having a lower limit of −20 degrees Celsius and an upper limit of 74 degrees Celsius. DC voltage transformer 14a is provided in order to be operated with DC voltage transformer 14a at an ambient temperature of between −20 degrees Celsius and 74 degrees Celsius.

The DC voltage transformer has a housing. In the present exemplifying embodiment, the housing of DC voltage transformer 14a is embodied separately from the respective housings 58a of inductive charging units 16a, 18a, 20a. DC voltage transformer 14a is disposed respectively at a distance from inductive charging units 16a, 18a, 20a. Inductive rechargeable battery charging apparatus 10a has an electrical connection 68a between energy reservoir 24a and DC voltage transformer 14a. Electrical connection 68a is embodied as a connecting cable. It is possible for inductive rechargeable battery charging apparatus 10a to have a plug connection that is provided in order to electrically connect DC voltage transformer 14a detachably to energy reservoir 24a.

In the present exemplifying embodiment, DC voltage transformer 14a is disposed adjacently to energy reservoir 24a. The inductive rechargeable battery charging apparatus has a plurality of electrical connections 70a, 72a, 74a between DC voltage transformer 14a and inductive charging units 16a, 18a, 20a. Electrical connections 70a, 72a, 74a are each embodied as a connecting cable. Inductive charging units 16a, 18a, 20a are disposed in a usable space of vehicle 12a. Each one of electrical connections 70a, 72a, 74a respectively connects one of inductive charging units 16a, 18a, 20a to DC voltage transformer 14a.

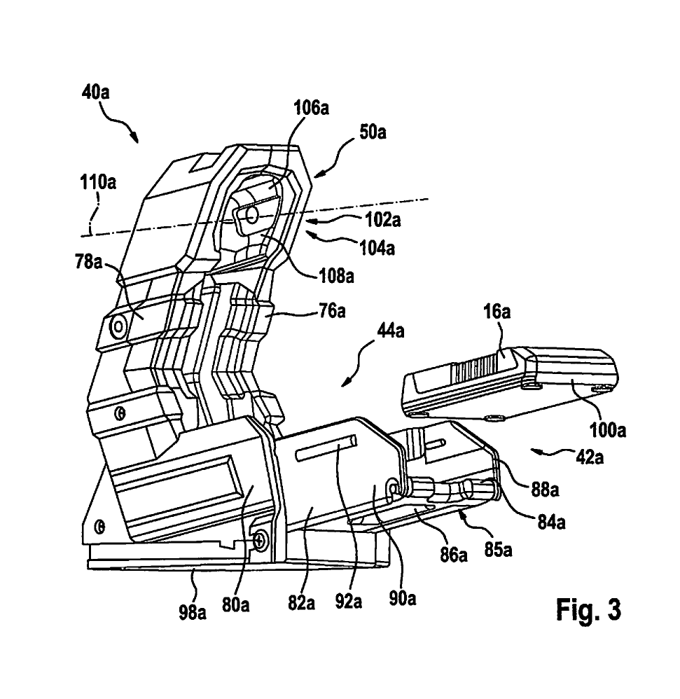

Inductive rechargeable battery charging apparatus 10a encompasses a plurality of holding units 40a each having a receptacle 42a for an inductive charging unit 16a. Holding units 40a are embodied analogously to one another, and only a first of holding units 40a will therefore be described in further detail below. Holding unit 40a has a respective further receptacle 44a for a rechargeable battery pack 46a, which is provided in order to immobilize rechargeable battery pack 46a at least for a charging operation (see FIG. 3). Holding unit 40a has a sliding-in direction for inductive charging unit 16a and for rechargeable battery pack 46a.

Holding unit 40a has two side elements 76a, 78a and a bottom element 80a. In the present exemplifying embodiment, side elements 76a, 78a are embodied as spars. It is alternatively possible for side elements 76a, 78a to be embodied as side plates. Side elements 76a, 78a are disposed parallel to one another. Holding unit 40a has a plane of symmetry that is disposed parallel to side elements 76a, 78a centrally between side elements 76a, 78a. At a lower end of holding unit 40a, side elements 76a, 78a enclose bottom element 80a. In an installed state, bottom element 80a connects side elements 76a, 78a. In the present exemplifying embodiment, holding unit 40a has an adapter element 82a that constitutes receptacle 44a for inductive charging unit 16a. It is alternatively possible for bottom element 80a to constitute receptacle 44a for inductive charging unit 16a. Receptacle 42a is trough-shaped. Receptacle 42a has two sills 84a. A first of sills 84a is disposed at a front side of receptacle 42a. A further one of the sills is disposed at a rear side of receptacle 42a. Sills 84a are each oriented perpendicularly to side elements 76a, 78a. Receptacle 42a has a shape corresponding to housing 58a of inductive charging unit 16a. A distance between sills 84a corresponds to a longitudinal dimension of housing 58a of inductive charging unit 16a. First sill 84a has a recess 85a that is provided for lifting and/or grasping of the inductive charging unit for removal from receptacle 42a.

Adapter element 82a is embodied as a drawer element. Adapter element 82a has a bottom element 86a and two side elements 88a, 90a. Adapter element 82a has a U-shaped cross section. Adapter element 82a is provided in order to be slid into bottom element 80a of holding unit 40a. Adapter element 82a has a plurality of guidance elements 92a provided in order to guide adapter element 82a upon a sliding-in operation into holding unit 40a. Guidance elements 92a are embodied as rails, shaped onto adapter element 82a, which are disposed in the sliding-in direction of holding unit 40a. Bottom element 80a has a plurality of groups of guidance receptacles 94a, 96a that are embodied correspondingly to guidance elements 92a of adapter element 82a. Guidance receptacles 94a, 96a are embodied as grooves. The groups of guidance receptacles 94a, 96a are at different distances from a bottom side 98a of holding unit 40a. Holding unit 40a is provided in order to support adapter element 82a at different distances from bottom side 98a. Holding unit 40a is provided in order to support adapter element 82a at different distances from bottom side 98a depending on dimensions, and/or on a type, of a rechargeable battery pack 46a.

The holding unit has a first conversion unit that is provided in order to convert a gravitational force into a positioning force acting at least substantially perpendicularly to the gravitational force. The conversion unit has oblique surfaces that are respectively disposed on first sill 84a of adapter element 82a and on the further threshold of adapter element 82a. Housing 58a of inductive charging unit 16a has two oblique surfaces 100a that are each provided in order to be in contact with one of the oblique surfaces of holding unit 40a when inductive charging unit 16a is in an inserted state.

Side elements 76a, 78a constitute further receptacle 44a for rechargeable battery pack 46a. Further receptacle 44a encompasses two guidance grooves. The guidance grooves are each introduced into one of side elements 76a, 78a. The guidance grooves are open toward a front side of receptacle 44a. The guidance grooves extend substantially from the front side toward the rear side of holding unit 40a. With holding unit 40a in an installed state, the guidance grooves extend substantially perpendicularly to a gravitational force. The guidance grooves are oriented substantially parallel to the sliding-in direction of holding unit 40a. The guidance grooves are provided in order to interact with correspondingly embodied guidance elements on rechargeable battery pack 46a. The guidance elements of rechargeable battery pack 46a are disposed laterally on rechargeable battery pack 46a. The guidance grooves and the guidance elements are provided for positive connection 68a to one another. Receptacle 44a has at a rear end of the guidance grooves a respective stop for the guidance elements of rechargeable battery pack 46a.

For a charging operation, inductive charging unit 16a is placed into receptacle 42a. Oblique surfaces 100a of inductive charging unit 16a come into contact with the oblique surfaces of receptacle 42a, and convert a gravitational force acting on inductive charging unit 16a into a positioning force for inductive charging unit 16a. Rechargeable battery pack 46a is slid, on an upper side of inductive charging unit 16a, into further receptacle 44a. The guidance elements of rechargeable battery pack 46a engage into the guidance grooves. The stop of the guidance grooves comes into contact with the guidance elements and limits an introduction movement of rechargeable battery pack 46a. Receptacle 44a immobilizes rechargeable battery pack 46a in a charging position relative to inductive charging unit 16a.

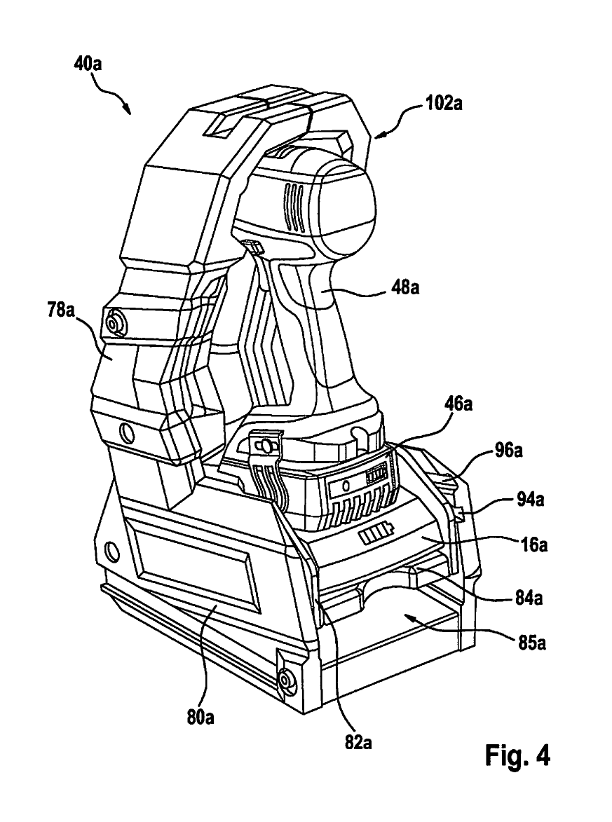

Holding unit 40a is provided in order to position the at least one inductive charging unit 16a and a handheld power tool 48a relative to one another for a charging operation. Holding unit 40a has a third receptacle 102a for handheld power tool 48a (see FIG. 4). Third receptacle 102a is provided in order to hold a head region of handheld power tool 48a. Third receptacle 102a is provided in order to hold a tool receptacle of handheld power tool 48a. Third receptacle 102a is disposed on an upper side of holding unit 40a. Third receptacle 102a is disposed between the two side elements 76a, 78a of holding unit 40a. Third receptacle 102a has a recess 104a. Recess 104a is delimited by an inner surface of receptacle 102a. The inner surface is substantially in the shape of a truncated conical enveloping surface. The inner surface is of substantially conical configuration. Receptacle 102a has a plane of symmetry that corresponds to the plane of symmetry of holding unit 40a. Receptacle 102a has four guidance grooves 106a, 108a that are oriented substantially perpendicularly to a gravitational force. Guidance grooves 106a, 108a define a downwardly tilted sliding-in direction of holding unit 40a for handheld power tool 48a. Guidance grooves 106a, 108a are provided in order to interact with correspondingly embodied guidance elements of handheld power tool 48a. Guidance grooves 106a, 108a are open toward a front side of receptacle 102a. Third receptacle 102a has, at a respective rear end of guidance grooves 106a, 108a, a stop for the guidance elements of handheld power tool 48a.

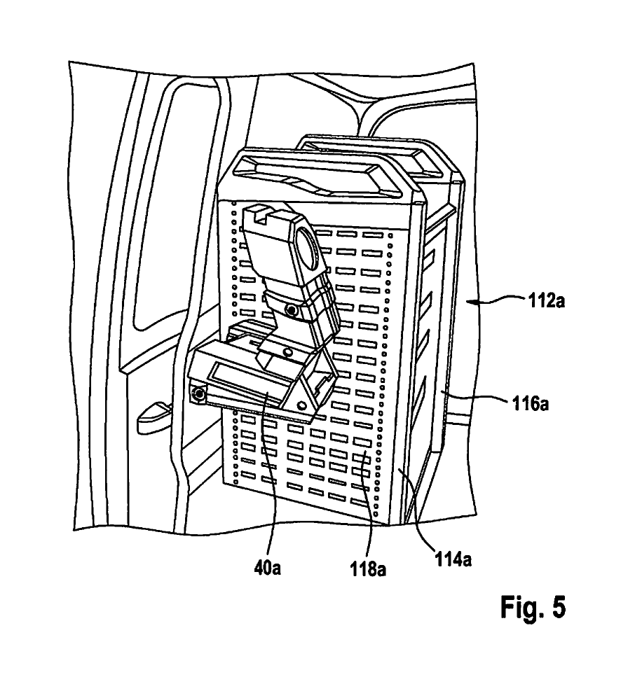

Holding unit 40a has a further conversion unit 50a that is provided in order to convert a gravitational force into a positioning force acting substantially perpendicularly to the gravitational force. Further conversion unit 50a encompasses recess 104a of third receptacle 102a. Recess 104a of third receptacle 102a has an axis 110a that is oriented substantially perpendicularly to a gravitational force. Axis 110a is tilted downward in the sliding-in direction of holding unit 40a. With vehicle 12a in an orientation as provided, conversion unit 50a converts a gravitational force acting on handheld power tool 48a into a positioning force in the sliding-in direction of holding unit 40a. Holding unit 40a is provided for installation in vehicle 12a. Holding unit 40a has installation elements that are provided in order to immobilize holding unit 40a in vehicle 12a. In the present exemplifying embodiment, the vehicle has a support system 112a that is embodied as a rack system. Support system 112a has a plurality of vertical carrying elements 114a, 116a that each have a perforated panel 118a (see FIG. 5). The installation elements are provided for threaded connection to a carrying element 114a, 116a of support system 112a. The installation elements are disposed laterally on side elements 76a, 78a of holding unit 40a.

In a method in which an inductive charging unit 16a in a vehicle 12a is supplied with energy by way of a DC transformer 14a, in a first step DC voltage transformer 14a is electrically connected to energy reservoir 24a of vehicle 12a. It is possible for DC voltage transformer 14a to be connected by way of a plug connection to energy reservoir 24a of vehicle 12a. In a further step, inductive charging unit 16a is placed into holding unit 40a. In a further step, a handheld power tool 48a coupled to a rechargeable battery pack 46a is inserted into the holding apparatus. It is also possible for rechargeable battery pack 46a to be integrated into a housing of handheld power tool 48a. Holding unit 40a positions handheld power tool 48a and inductive charging unit 16a relative to one another for a charging operation. Inductive charging unit 16a detects that rechargeable battery pack 46a is disposed in the charging position, and starts the charging operation. For the charging operation, DC voltage transformer 14a supplies inductive charging unit 16a with electrical energy from energy reservoir 24a of vehicle 12a.

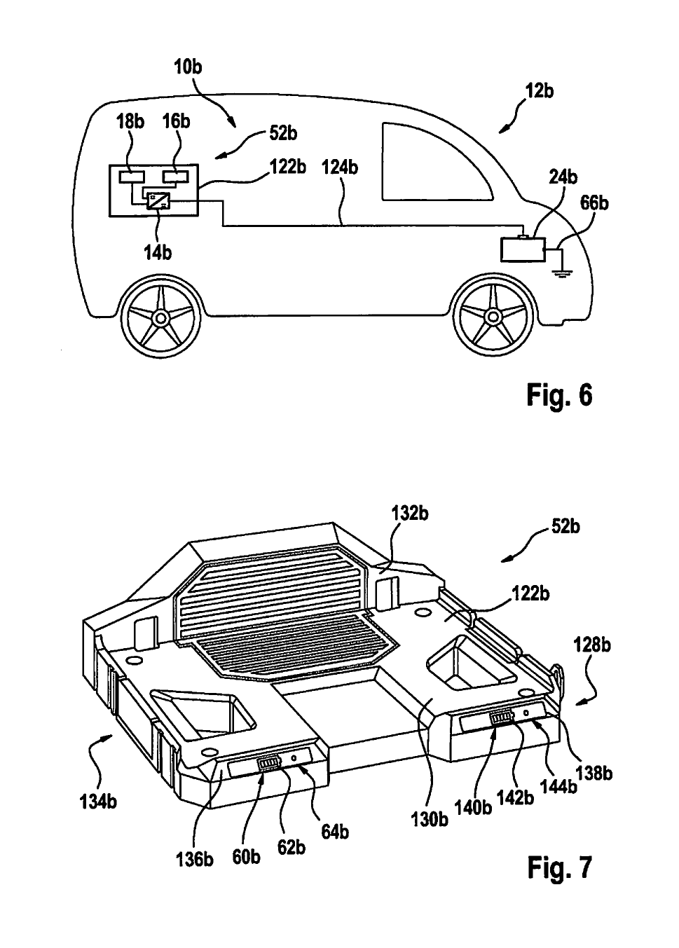

FIGS. 6 to 9 show two further exemplifying embodiments of the invention. The description below and the figures are limited substantially to the differences between the exemplifying embodiments; with regard to identically designated components, in particular with regard to components having identical reference characters, reference may in principle also be made to the drawings and/or the description of the other exemplifying embodiments, in particular to FIGS. 1 to 5. In order to differentiate the exemplifying embodiments, the reference characters of the exemplifying embodiments in FIGS. 1 to 5 are followed by the letter “a”. In the exemplifying embodiments of FIGS. 6 to 9, the letter “a” is replaced by the letters “b” and “c”.

FIG. 6 shows a further exemplifying embodiment of an inductive rechargeable battery charging apparatus 10b for a vehicle 12b, having a DC voltage transformer 14b and an inductive charging unit 16b, 18b that is provided in order to supply energy by way of DC voltage transformer 14b. Analogously to the preceding exemplifying embodiment, inductive rechargeable battery charging apparatus 10b is provided in order to charge rechargeable battery packs, and has exactly one DC voltage transformer 14b. Vehicle 12b has an energy reservoir 24b that is provided in order to supply an electrical system of vehicle 12b with electrical energy. Vehicle 12b has an electrical connection 66b between energy reservoir 24b and an electrical ground. DC voltage transformer 14b is provided in order to transform a voltage of energy reservoir 24b into a higher voltage in order to supply power to the at least one inductive charging unit 16b, 18b. Energy reservoir 24b has a rated voltage of 12 V. DC voltage transformer 14b is provided in order to transform the output voltage of energy reservoir 24b (12 V) into an input voltage of inductive charging units 16b, 18b (300 V).

In contrast to the preceding exemplifying embodiment, inductive rechargeable battery charging apparatus 10b encompasses a charging bay 52b in which two inductive charging units 16b, 18b are disposed (see FIG. 7). It is possible for inductive rechargeable battery charging apparatus 10b to encompass a plurality of charging bays 52b. It is possible for charging bay 52b to encompass a number of inductive charging units 16b, 18b differing from two, for example one or more than two inductive charging units 16b, 18b. Charging bay 52b has a housing 122b in which DC voltage transformer 14b and inductive charging units 16b, 18b are disposed. Inductive rechargeable battery charging apparatus 10b has an electrical connection 124b that connects charging bay 52b to energy reservoir 24b of vehicle 12b.

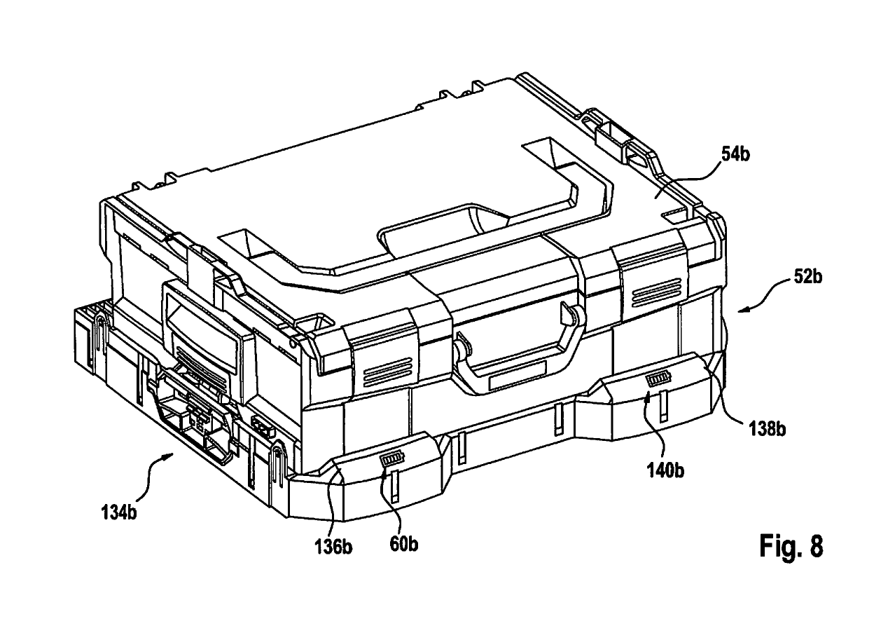

Charging bay 52b is provided for reception 102a of a handheld tool case 54b. In the present exemplifying embodiment, handheld tool case 54b is provided in order to store and/or transport a handheld power tool and/or a rechargeable battery pack. Charging bay 52b encompasses a carrier unit 128b that is provided in order to support handheld tool case 54b in a support region (see FIG. 8). It is possible for carrier unit 128b to be provided in order to support differently embodied handheld tool cases 54b that differ, for example, in terms of a material; a shape, in particular a height; and/or a type. In the present exemplifying embodiment, carrier unit 128b is embodied as an angled element. Carrier element 128b encompasses a base plate 130b and a back element 132b. Base plate 130b and back element 132b are disposed at least substantially perpendicularly to one another. Base plate 130b and back element 132b constitute a concave edge of carrier unit 128b. Charging bay 52b has a principal insertion direction that is disposed substantially parallel to base plate 130b of carrier unit 128b and perpendicularly to back element 132b. Base plate 130b and back element 132b are connected to one another at the concave edge. In the present exemplifying embodiment, base plate 130b and back element 132b are connected integrally to one another. Base plate 130b is of rectangular configuration.

Carrier unit 128b has a linear guidance unit that is provided in order to orient the handheld tool case relative to the charging module in the support region. Carrier unit 128b encompasses a latching unit 134b that is provided in order to connect handheld tool case 54b to carrier unit 128b and hold it in a charging position.

Carrier unit 128b has two stop elements 136b, 138b that are each provided in order to interact with a delimiting edge of handheld tool case 54b. Stop elements 136b, 138b are each embodied as a sill. Stop elements 136b, 138b are disposed on an edge of base plate 130b located oppositely from back element 134b. In the present exemplifying embodiment, stop elements 136b, 138b are embodied integrally with base plate 130b. Stop elements 136b, 138b each have an oblique surface that is provided in order to interact with a delimiting edge of handheld tool case 54b. Stop elements 136b, 138b delimit the support region of the handheld tool case.

The inductive charging units each encompass an indicating unit 60b, 140b that, in an installed state, is disposed oppositely from back element 134b with reference to the support region. Analogously to the preceding exemplifying embodiment, indicating units 60b, 140b each have a display 62b, 142b and a plurality of LEDs 64b, 144b that are provided in order to indicate states of a charging operation. Indicating units 60b, 138b are each arranged on a side, facing away from the support region, of stop elements 136b, 138b of carrier unit 128b which are embodied as sills.

In an insertion operation in which carrier unit 128b is disposed in the first orientation, the gravitational force presses handheld tool case 54b against stop elements 136b, 138b. The delimiting edge comes into contact with oblique surfaces of stop elements 136b, 138b, and the oblique surfaces exert on the handheld tool case a force directed toward back element 134b. An orientation of the handheld tool case parallel to the base plate of the carrier unit indicates to a user the disposition provided for the handheld tool case in the support region.

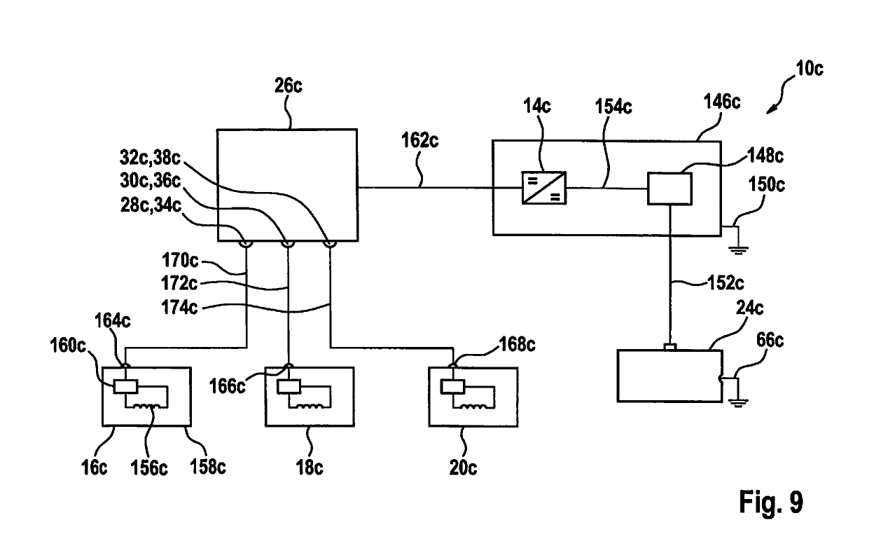

FIG. 9 shows a further exemplifying embodiment of an inductive rechargeable battery charging apparatus 10c for a vehicle 12c, having a DC voltage transformer 14c and an inductive charging unit 16c, 18c, 20c, which is provided in order supply energy by way of DC voltage transformer 14c. Analogously to the preceding exemplifying embodiments, inductive rechargeable battery charging apparatus 10c is provided in order charge rechargeable battery packs, and has exactly one DC voltage transformer 14c. The vehicle has an energy reservoir 24c that is provided in order supply an electrical system of the vehicle with electrical energy. Vehicle 12c has an electrical connection 66c between energy reservoir 24c and an electrical ground. DC voltage transformer 14c is provided in order to transform a voltage of energy reservoir 24c into a higher voltage for supplying power to the at least one inductive charging unit 16c, 18c, 20c.

Energy reservoir 24c has a rated voltage of 12 V. DC voltage transformer 14c is provided in order to transform the output voltage of energy reservoir 24c (12 V) into an input voltage of inductive charging units 16c, 18c, 20c (325 V).

Inductive rechargeable battery charging apparatus 10c has a voltage supply unit 146c that encompasses DC voltage transformer 14c and a filter 148c. Voltage supply unit 146c has an electrical connection 150c to electrical ground. Filter 148c is provided in order to protect a vehicle electrical system from signals proceeding from DC voltage transformer 14c. In the present exemplifying embodiment, filter 148c is embodied as a blocking filter. Filter 148c is disposed in terms of circuit engineering between energy reservoir 24c and DC voltage transformer 14c. Inductive rechargeable battery charging apparatus 10c has an electrical connection 152c between energy reservoir 24c and filter 148c. Inductive rechargeable battery charging apparatus 10c has an electrical connection 154c between filter 148c and DC voltage transformer 14c.

In the present exemplifying embodiment, inductive rechargeable battery charging apparatus 10c has a plurality of inductive charging units 16c, 18c, 20c. In the present exemplifying embodiment, inductive charging units 16c, 18c, 20c are embodied analogously to one another, and only a first of inductive charging units 16c, 18c, 20c will therefore be described in further detail below. Inductive charging unit 16c, 18c, 20c is provided in order to charge a rechargeable battery pack in a charging operation. Inductive charging unit 16c, 18c, 20c has a charging coil 156c and a housing 158c. Charging coil 156c is embodied as a primary coil. Charging coil 156c is provided for inductive energy transfer to the rechargeable battery pack.

Charging coil 156c is provided in order to transmit, i.e. radiate, energy. Inductive charging unit 16c, 18c, 20c has a filter 160c that is disposed in terms of circuit engineering between charging coil 156c and a supply input of inductive charging unit 16c, 18c, 20c. Filter 160c is provided in order to protect a current source, connected to the supply input, from a signal of inductive charging unit 16c, 18c, 20c.

In contrast to the preceding exemplifying embodiments, inductive rechargeable battery charging apparatus 10c has a distributor unit 26c that has a plurality of terminals 28c, 30c, 32c that are provided for temporary connection to a respective inductive charging unit 16c, 18c, 20c. Distributor unit 26c is provided in order to distribute a charging energy, furnished by energy reservoir 24c, to inductive charging units 16, 18c, 20c. Inductive rechargeable battery charging apparatus 10c has an electrical connection 162c between DC voltage transformer 14c and distributor unit 26c.

Inductive rechargeable battery charging apparatus 10c has a plurality of plug connections 34c, 36c, 38c, 164c, 166c, 168c. Three of plug connections 34c, 36c, 38c are respectively provided in order to connect one of inductive charging units 16c, 18c, 20c selectably to distributor unit 26c or to an electrical grid connection. In the present exemplifying embodiment, inductive rechargeable battery charging apparatus 10c has six plug connections 34c, 36c, 38c, 164c, 166c, 168c. Inductive rechargeable battery charging apparatus 10c has three electrical connections 170c, 172c, 174c respectively between terminals 28c, 30c, 32c of distributor unit 26c and one of inductive charging units 16c, 18c, 20c. Distributor unit 26c is disposed in terms of circuit engineering between DC voltage transformer 14c and the respective inductive charging units 16c, 18c, 20c. In the present exemplifying embodiment, distributor unit 26c is embodied as a distributor box. Electrical connections 170c, 172c, 174c are embodied as connecting cables. Plug connections 34c, 36c, 38c, 164c, 166c, 168c are each disposed at one end of electrical connections 170c, 172c, 174c. Plug connections 34c, 36c, 38c, 164c, 166c, 168c are each provided for detachable electrical connection between inductive charging units 16c, 18c, 20c and distributor unit 26c. Plug connections 34c, 36c, 38c, respectively disposed at a distributor-side end of electrical connections 170c, 172c, 174c, each have a plug connector element that is provided for connection to an electrical grid socket of an electrical power grid. The electrical power grid furnishes a supply current that has an effective voltage of approximately 230 V and a frequency of approximately 50 Hz. It is also possible for plug connections 34c, 36c, 38c, disposed at the distributor-side end of electrical connections 170c, 172c, 174c, each to have an adapter element that is provided in order to connect the plug connector element to the electrical grid socket.

Inductive charging units 16c, 18c, 20c are provided in order to be selectably supplied with direct current or alternating current. Inductive charging units 16c, 18c, 20c each have a functional unit that is provided in order to automatically detect a frequency of an applied supply voltage. The functional unit is embodied as part of an electronic charging system that is provided in order to supply energy to charging coil 156c.

1-13. (canceled)

14. An inductive rechargeable battery charging apparatus for a vehicle, comprising:
at least one DC voltage transformer; and
at least one inductive charging unit to supply energy by way of the DC voltage transformer.

15. The inductive rechargeable battery charging apparatus as recited in claim 14, wherein the DC voltage transformer is designed to transform a voltage of an energy reservoir into a higher voltage to supply power to the at least one inductive charging unit.

16. The inductive rechargeable battery charging apparatus as recited in claim 14, wherein the DC voltage transformer has a service temperature range having a lower limit of at maximum −10 degrees Celsius and an upper limit of at minimum 50 degrees Celsius.

17. The inductive rechargeable battery charging apparatus as recited in claim 14, wherein the at least one inductive charging unit is supplied selectably with direct current or alternating current.

18. The inductive rechargeable battery charging apparatus as recited in claim 17, wherein the at least one inductive charging unit includes a functional unit that automatically detects a frequency of an applied supply voltage.

19. The inductive rechargeable battery charging apparatus as recited in claim 14, further comprising:
a plurality of inductive charging units to supply energy by way of the at least one DC voltage transformer.

20. The inductive rechargeable battery charging apparatus as recited in claim 19, further comprising:
at least one distributor unit having a plurality of terminals for at least temporary connection to a respective inductive charging unit.

21. The inductive rechargeable battery charging apparatus as recited in claim 20, further comprising:
at least one plug connection to connect at least one of the plurality of inductive charging units selectably to the distributor unit or to an electrical grid connection.

22. The inductive rechargeable battery charging apparatus as recited in claim 14, further comprising:
at least one holding unit having a receptacle for the at least one inductive charging unit and a further receptacle for at least one rechargeable battery pack, the holding unit to immobilize the rechargeable battery pack at least for a charging operation.

23. The inductive rechargeable battery charging apparatus as recited in claim 14, further comprising:
at least one holding unit to position the at least one inductive charging unit and at least one handheld power tool relative to one another for a charging operation.

24. The inductive rechargeable battery charging apparatus as recited in claim 22, wherein the holding unit has at least one conversion unit to convert a gravitational force into a positioning force acting at least substantially perpendicularly to the gravitational force.

25. The inductive rechargeable battery charging apparatus as recited in claim 14, wherein at least one charging bay encompasses the at least one inductive charging unit, the charging bay for reception of at least one handheld tool case.

26. A method, comprising:
providing an inductive charging unit in a vehicle; and
supplying the inductive charging unit with energy by way of a DC voltage transformer.
